(19) United States
(12) Patent Application Publication
(10) Pub. No.: US 2024/0293199 A1
(43) Pub. Date: Sep. 5, 2024

(54) APPLICATOR TIP FOR ROOT CANAL SEALER

(71) Applicant: KING FAISAL UNIVERSITY, AL-AHSA (SA)

(72) Inventors: ANIL BANGALORE SHIVAPPA, AL-AHSA (SA); NAZARGI MAHABOB, AL-AHSA (SA)

(21) Appl. No.: 18/177,565

(22) Filed: Mar. 2, 2023

(51) Int. Cl. A61C 5/50

(52) U.S. Cl. CPC A61C 5/50

(57) ABSTRACT

The applicator tip for root canal sealer is used to coat walls of a root canal with root canal sealer prior to filling the root canal with a filler material. The applicator tip is formed from a hollow shell having a connection portion and an application portion. The connection portion is adapted for connection to a supply of root canal sealer, such as a source of pressurized adhesive cement or the like. The application portion has a proximal end and a distal end, a diameter of the application portion continuously decreasing from the proximal end to the distal end. A plurality of recesses are defined in an outer surface of the application portion of the hollow shell, and a plurality of radially spaced frustoconical openings extend through the application portion of the hollow shell, such that each of the openings is centrally located within a corresponding one of the recesses.

### BACKGROUND

### 1. Field

The disclosure of the present patent application relates to root canal procedures, and particularly to an applicator tip for root canal sealer for applying a sealer, such as an adhesive cement, to the walls of a root canal prior to the filling thereof with a filling material, such as gutta-percha.

### 2. Description of the Related Art

FIGS. 2A-2F illustrate a typical root canal procedure, beginning with an infected tooth T, which, as shown in FIG. 2A, typically has decay extending through the dentin D and into the pulp P, often resulting in the formation of an abscess A. As shown in FIG. 2B, an opening O is made in the tooth T with a drill or the like, completely removing the decayed portion and providing access to the pulp P. As shown in FIG. 2C, once the opening is made, the infected pulp is removed using a dental file For the like, leaving open root canals C, which are then cleaned and disinfected. The root canals C are then filled with a filler material, such as gutta-percha GP, which is applied and packed into the root canals C using a plugger PL or the like, as shown in FIG. 2D. Following the filling with gutta-percha, the opening in the tooth T is filled with a filling FL, and a post PS may be inserted for additional support, as shown in FIG. 2E. As shown in FIG. 2F, the final step in the procedure is the cementing of a crown CR onto the tooth T, resulting in a finished rebuilt tooth.

The filling of the clean root canals C with the gutta-percha GP in FIG. 2D is referred to as “obturation”. Gutta-percha is the most common filler material used during obturation. However, on its own, gutta-percha has no adhesive properties. Thus, gutta-percha must be applied using some type of sealer, which is typically an adhesive cement or the like. Conventionally, the sealer is either mixed with the gutta-percha, or a gutta-percha plug or capsule is prepared and then coated with the sealer prior to insertion into the root canals. These common techniques, however, do not guarantee a uniform and even distribution of the sealer, thus making the gutta-percha susceptible to the formation of voids, which may result in microleakage within the rebuilt tooth. Such microleakage may result in re-infection and require a second root canal procedure to repair the damage within the same tooth. In order to prevent such an occurrence, it is important that the sealer be applied evenly and uniformly to make full and fluid-tight contact with the walls of the prepared root canals.

Thus, an applicator tip for root canal sealer solving the aforementioned problems is desired.

### SUMMARY

The applicator tip for root canal sealer is used to coat the walls of a root canal with root canal sealer prior to filling the root canal with a filler material, such as gutta-percha. The applicator tip is formed from a hollow shell having a connection portion and an application portion. The connection portion is adapted for connection to a supply of root canal sealer, such as a source of pressurized adhesive cement or the like. The application portion has a proximal end and a distal end, the diameter of the application portion continuously decreasing from the proximal end to the distal end. A plurality of recesses are formed in an outer surface of the application portion of the hollow shell, and a plurality of openings are formed in the application portion of the hollow shell, such that each of the openings is centrally located within a corresponding one of the recesses. Each of the openings constantly increases in diameter extending from the interior of the applicator tip to the recess opening in the outer surface of the applicator tip, the openings having a frustoconical or inverted funnel shape. The application portion is preferably made of a flexible material, allowing it to flex to match the contour of the root canal in which it is inserted.

In use, the applicator tip is connected to a supply of root canal sealer and inserted into the root canal. The root canal sealer is then injected through the openings formed through the application portion of the hollow shell of the applicator tip such that the root canal sealer coats the walls of the root canal. Once the root canal sealer has been evenly applied to the walls of the root canal, the applicator tip is removed and the root canal is filled with filler material, such as gutta-percha, in a conventional manner.

These and other features of the present subject matter will become readily apparent upon further review of the following specification and drawings.

### BRIEF DESCRIPTION OF THE DRAWINGS

FIG. 1A is a side view of an applicator tip for root canal sealer.

FIG. 1B is an environmental side view of the applicator tip for root canal sealer, showing the applicator tip inserted into a root canal in a tooth.

FIG. 1C is a side view of an applicator tip for root canal sealer.

FIG. 1D is a section view drawn along lines 1D-1D of FIG. 1C

FIGS. 2A is a schematic diagram of an infected tooth in need of a root canal procedure.

FIG. 2B is a schematic diagram of the tooth of FIG. 2A after forming an opening in the tooth and cleaning out the infected portion.

FIG. 2C is a schematic diagram of the tooth of FIG. 2B after removal of the infected pulp.

FIG. 2D is a schematic diagram of the tooth of FIG. 2C after filling the root canals with a filler material.

FIG. 2E is a schematic diagram of the tooth of FIG. 2D after filling the opening in the tooth and inserting a post.

FIG. 2F is a schematic diagram of the tooth of FIG. 2E after cementing a crown onto the tooth.

Similar reference characters denote corresponding features consistently throughout the attached drawings.

### DETAILED DESCRIPTION OF THE PREFERRED EMBODIMENTS

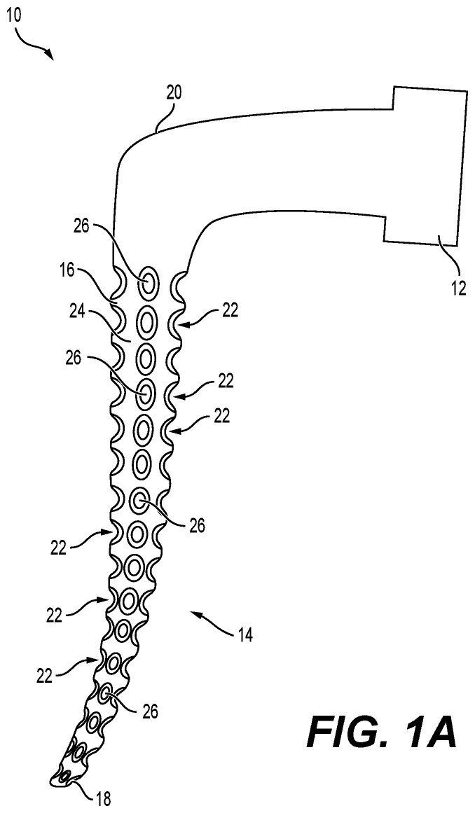

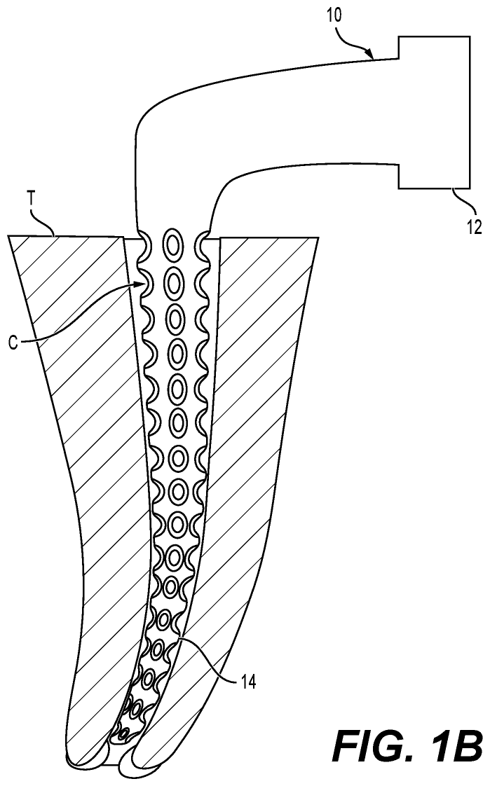

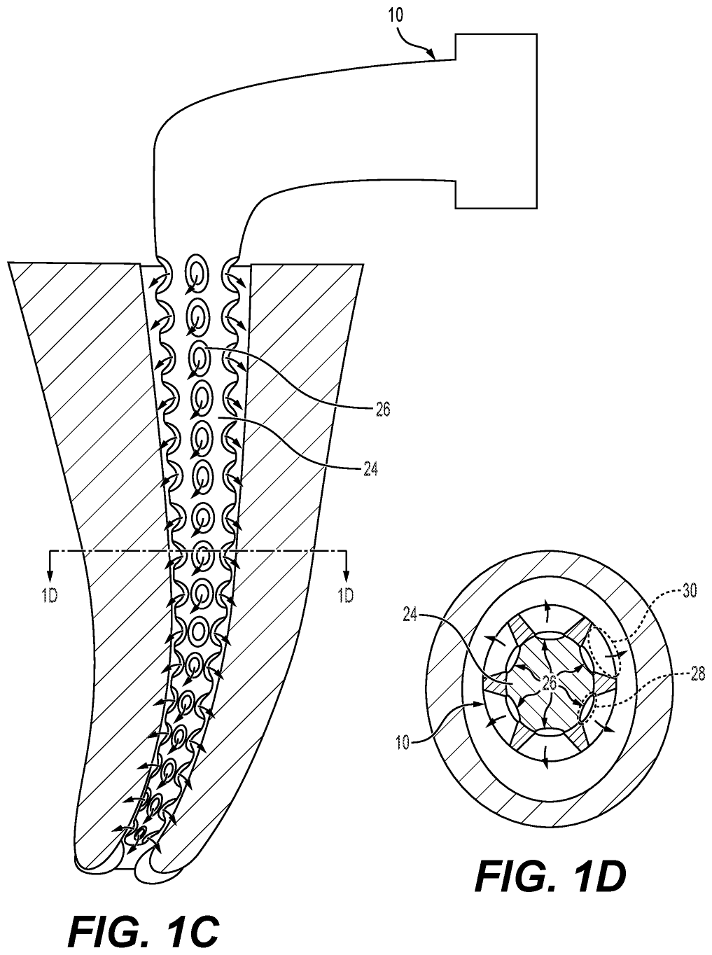

The applicator tip for root canal sealer 10 is used to coat walls of a root canal with root canal sealer prior to filling the root canal with a filler material, such as gutta-percha. As shown in FIGS. 1A and 1B, the applicator tip 10 is formed from a hollow shell 20 having a connection portion 12 and an application portion 14. The connection portion 12 is adapted for connection to a supply of root canal sealer, such as a source of pressurized adhesive cement or the like. It should be understood that the shape, relative dimensions and overall configuration of the connection portion 12 are shown for exemplary purposes only, and that connection portion 12 may be configured appropriately for connection to any suitable supply of the root canal sealer, including any necessary fixtures, gaskets, valves, connectors, adaptors or the like.

The application portion 14 has a proximal end 16 and a distal end 18, the diameter of the application portion 14 continuously decreasing from the proximal end 16 to the distal end 18, as shown in FIG. 1A. As further shown in FIG. 1A, a plurality of recesses 22 are formed in an outer surface 24 of the application portion 14 of the hollow shell 20, and a plurality of radially spaced openings 26 extend through the application portion 14 of the hollow shell 20, such that each of the openings 26 is centrally located within a corresponding one of the recesses 22. The openings 26 are in open communication with the hollow interior 28 of the hollow shell 20, allowing the root canal sealer to flow from hollow interior 28 to the exterior of application portion 14 to coat the walls of the root canal. As shown in FIG. 1D, the walls of each opening are diverging as they extend from the interior of the applicator tip to the outer surface of the tip 10, so that each of the openings 26 has a substantially frustoconical or inverted funnel shape, with the smaller diameter end 28 facing the central channel inside the applicator tip 10 and the larger diameter end 30 of the opening 26 defined on the outer surface of the applicator tip 10. The effect of this configuration is that the sealer has a tendency to spread outward towards the neighboring openings 26 as it is squeezed or pushed through the opening 26, resulting in a more uniform coating of the sealer in the root canals prior to applying the filler. As shown in FIG. 1B, the application portion 14 is preferably made of a flexible material, allowing it to flex to match the contour of the root canal C in which it is inserted. It should be understood that the relative dimensions of the applicator tip 10 are shown for exemplary purposes only and that, further, applicator tips 10 may be manufactured in a variety of different sizes with differing relative dimensions, depending upon the type of tooth undergoing root canal and depending on the age of the patient.

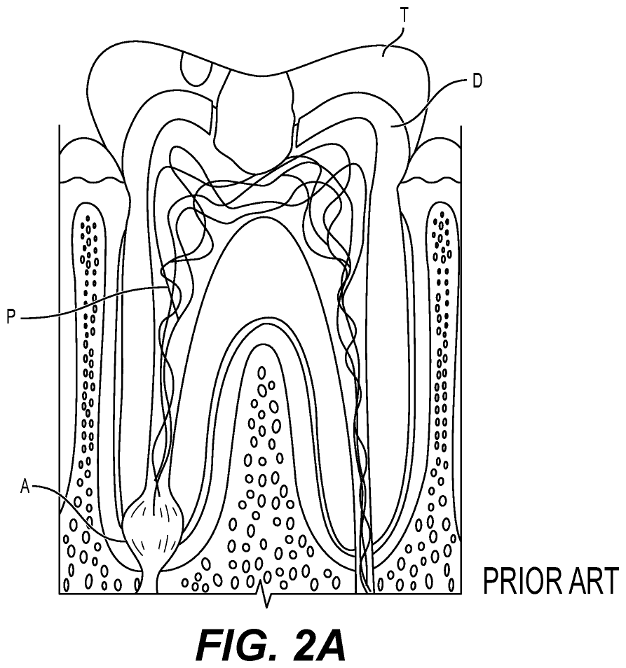

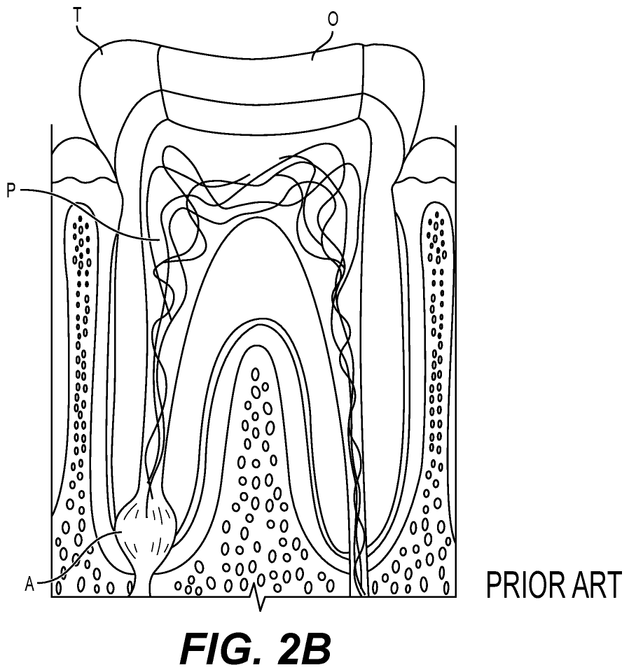

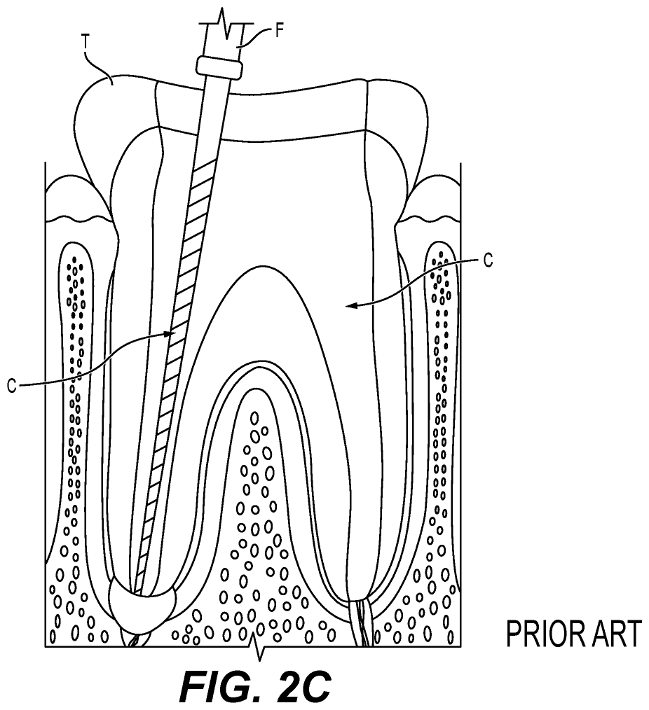

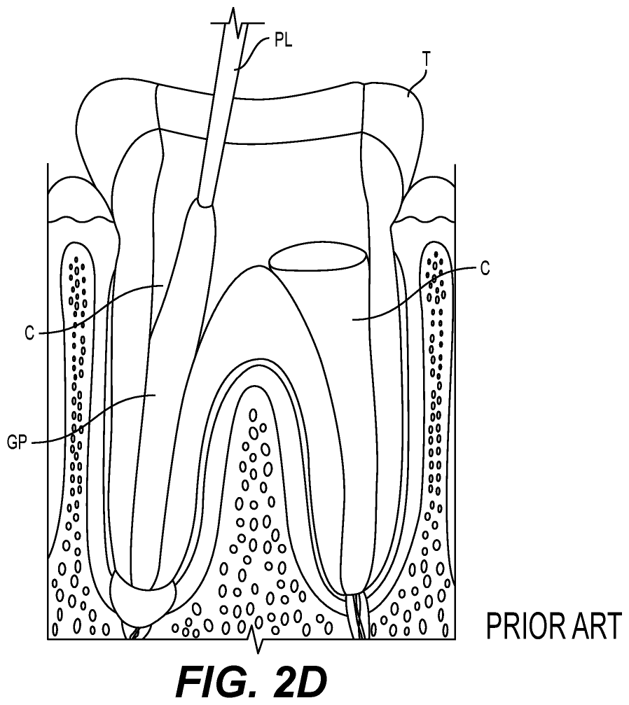

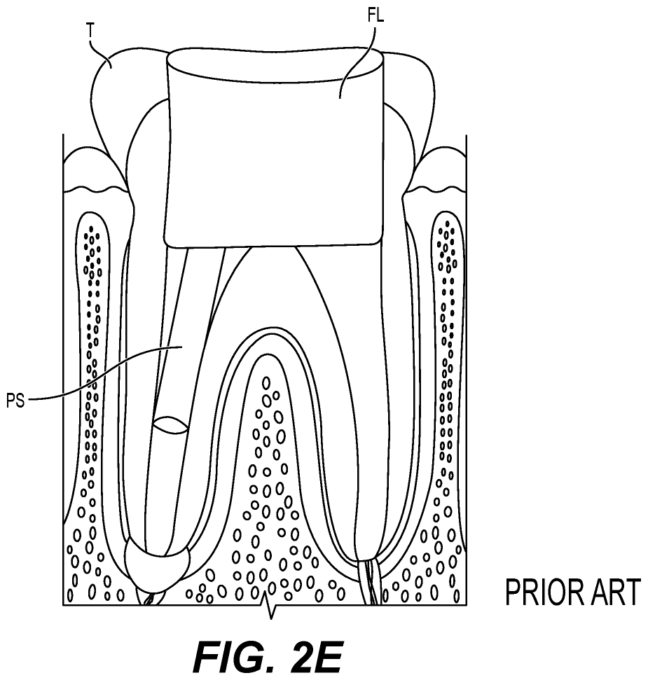

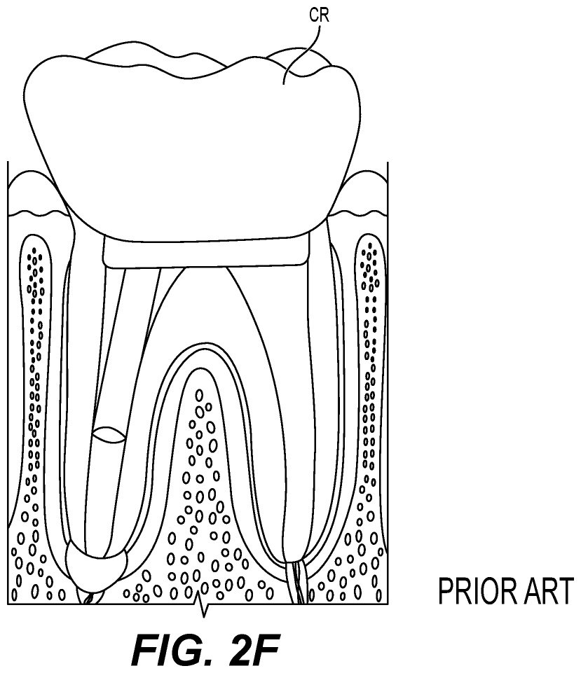

In use, the applicator tip 10 is connected to a supply of root canal sealer and inserted into the root canal C. The root canal sealer is then injected through the openings 26 formed through the application portion 14 of the hollow shell 20 of the applicator tip 10 such that the root canal sealer coats the walls of the root canal C. As the sealer is pushed through each opening, the sealant spreads out with the increasing diameter of the opening so that the spreads from one recess to its neighboring recesses, providing a uniform coating of sealer in the root canals. Once the root canal sealer has been evenly applied to the walls of the root canal C, the applicator tip 10 is removed and the root canal C is filled with filler material, such as gutta-percha, in a conventional manner, such as that described above with respect to FIG. 2D. As the gutta-percha flows through each opening 26, it spreads out within the corresponding recess 22 before flowing out of the recess 22 and onto the wall of the root canal C. This spreading effects the even and uniform distribution of the gutta-percha during its application on the wall of the root canal C.

It is to be understood that the applicator tip for root canal sealer is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An applicator tip for root canal sealer, comprising a hollow shell having:
a connection portion adapted for connection to a supply of root canal sealer; and
an application portion having a proximal end and a distal end, the application portion continuously decreasing in diameter from the proximal end to the distal end, the application portion having an outer surface and a plurality of recesses defined in the outer surface, the application portion defining a central channel for passage of root canal sealer through the applicator tip, the application portion having a plurality of radially spaced frustoconical openings extending through the application portion of the hollow shell to the outer surface, each of the frustoconical openings being centrally located within a corresponding one of the recesses, wherein each of the radially spaced frustoconical openings has diverging walls extending between a smaller diameter end facing the central channel inside the applicator tip and a larger diameter end in the outer surface of the hollow shell, whereby the root canal sealer spreads out towards neighboring frustoconical openings as the sealer passes through the frustoconical opening, resulting in a uniform coating of the sealer in the root canal.

2. (canceled)

3. The applicator tip as recited in claim 1, wherein the application portion is made of a flexible material.

4. A method of performing root canal obturation, comprising the steps of:
connecting the applicator tip according to claim 1 to a supply of root canal sealer;
inserting the applicator tip into a root canal in a tooth;
injecting the root canal sealer through the frustoconical openings formed through the application portion of the hollow shell of the applicator tip such that the root canal sealer coats walls of the root canal;
removing the applicator tip from the root canal; and
filling the root canal with a filler material.
